(19) United States
(12) Patent Application Publication
(10) Pub. No.: US 2010/0213278 A1
(43) Pub. Date: Aug. 26, 2010

(54) STEAM SPRAYING NOZZLE

(75) Inventor: Yang ZAN, Fujian Province (CN)

Correspondence Address: RABIN & Berdo, PC, 1101 14TH STREET, NW, SUITE 500, WASHINGTON, DC, 20005, US

(73) Assignee: Tsann Kuen (Zhangzhou) Enterprise Co., Ltd., Fujian Province (CN)

(21) Appl. No.: 12/699,287

(22) Filed: Feb. 3, 2010

(30) Foreign Application Priority Data
Feb. 23, 2009 (CN) 200920136847.7

(51) Int. Cl. B05B 15/00

(52) U.S. Cl. 239/289

(57) ABSTRACT

The present invention relates to a steam spraying nozzle for spraying fragrant steam which overcomes the problem of uncontrollable fragrance consumption quantity in the conventional technique. The steam spraying nozzle comprises multiple steam outlets disposed on its sealing casing main body. A steam inlet in the main body is connected to a steam generator. A window is set on the main body and equipped with a fragrance box with multiple pores. Steam flows into the inner space of the main body through the steam inlet then flows into the fragrance box by the pores of the fragrance box. Then the steam sprays out of the steam outlets from the pores of the fragrance box. The fragrance box can restrict overflow of the steam to the fragrance, so consumption of the fragrance can be controlled and if necessary, partial pores are closed to further reduce consumption of fragrance.

### FIELD OF THE INVENTION

The present invention relates to a steam spraying nozzle which is able to spray fragrant steam.

### BACKGROUND OF THE INVENTION

In the conventional steam spraying nozzle, a plurality of steam outlets are set on the sealing casing main body, said main body is disposed with a steam inlet which is connected to a steam source. In order to spray fragrant steam from the above steam spraying nozzle, the main body of the steam spraying nozzle is disposed with a window, a cover is equipped to the window; then the steam is driven to flow into the inner space of the main body through the steam inlet, then overflows the fragrance and sprays outside of the steam outlet. Thereby the steam of the steam spraying nozzle is fragrant. However, there are still some shortages: the consumption quantity of the fragrance can not be controlled, it needs to add fragrance frequently because the consumption speed is rapidly.

### SUMMARY OF THE INVENTION

The objective of the present invention is to provide a steam spraying nozzle, it can control the consumption quantity of the fragrance.

The technical solution applied in the present invention is: a steam spraying nozzle, with multiple steam outlets disposed on its sealing casing main body, said main body has a steam inlet which is connected to a steam source, a window is set on the main body and equipped with a fragrance box with multiple pores. The steam flows into the inner space of the main body by the steam inlet, and overflows the fragrance through the pores of the fragrance box, then sprays outside of the steam outlet from the pores of the fragrance box. The fragrance box can restrict the overflow of the steam to the fragrance, so the consumption quantity of the fragrance can be controlled and if necessary, partial pores are closed to further reduce the consumption quantity of the fragrance.

The top of the main body of the fragrance box comprises an opening on the top side with a cover, so it is convenient to add the fragrance.

In a preferred embodiment: said fragrance box is rectangular; multiple pores are respectively set on the bottom wall\ left wall\ right wall and back wall of said fragrance box and said cover

A sliding unit, is disposed between two opposite walls of said fragrance box and said cover; wherein said sliding unit comprises a sliding slot and sticking point cooperate with each other. Thus, it is not only convenient to open and close the cover of the fragrance box, but also the cover will not easily to be removed.

The steam spraying nozzle of the present invention, a window is set on its main body and equipped with a fragrance box with multiple pores, so the drawback of the uncontrollable of fragrance consumption quantity is overcome. The structure is simple and efficient. Moreover, it is convenient to add the fragrance.

### BRIEF DESCRIPTION OF THE DRAWINGS

FIG. 1 is the structural view of the steam spraying nozzle of an embodiment of the present invention.

FIG. 2 is the exploded view of the embodiment of FIG. 1.

FIG. 3 is the exploded view of the fragrance box of the embodiment of FIG. 1.

### DETAILED DESCRIPTION OF THE EMBODIMENTS

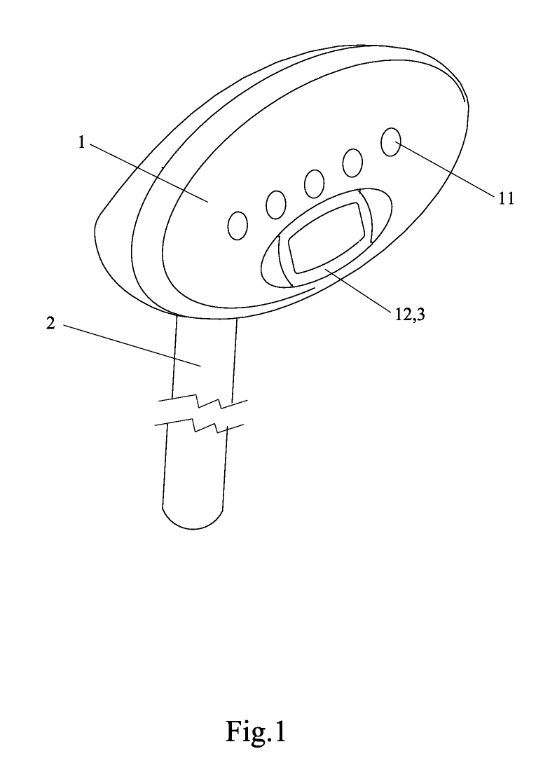

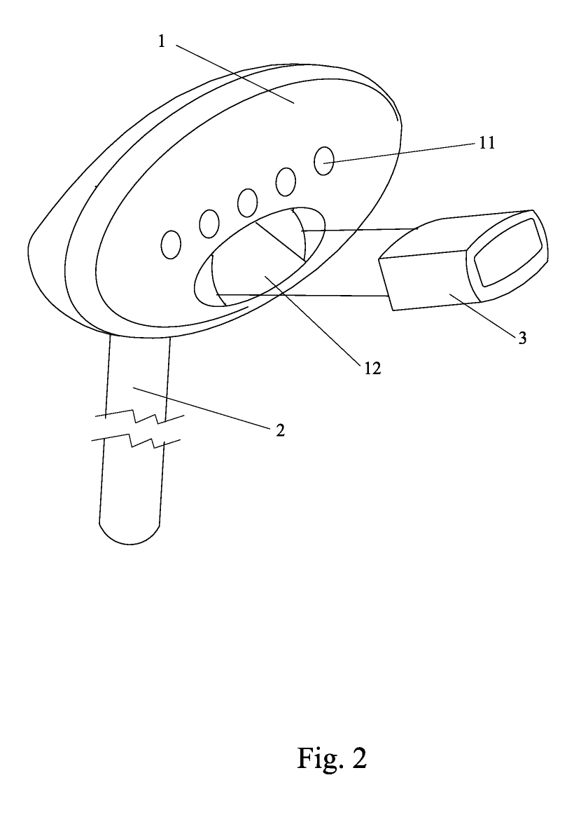

As showed in FIG. 1 and FIG. 2, the structure of an embodiment of the steam spraying nozzle of the present invention, it has a sealing casing main body 1, multiple steam outlets 11 and a window 12 are disposed on its sealing casing main body 1, said main body 1 has a steam inlet 2 which is connected to a steam source, said window 12 of main body 1 is equipped with a fragrance box 3.

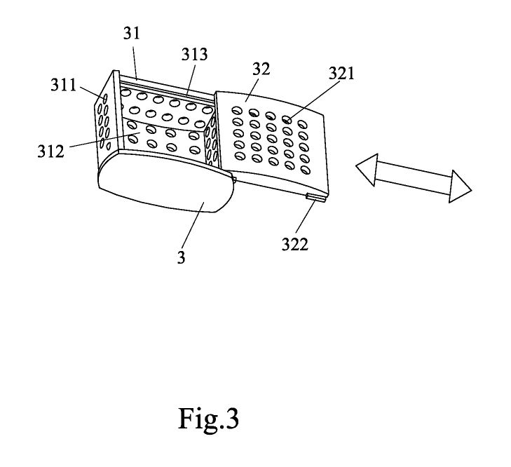

Please refer to FIG. 3, the main body 31 of the fragrance box 3 is rectangular, it comprises an opening on the top side with a cover 32.

Multiple pores 311 are respectively set on the bottom wall\ left wall\ right wall and back wall of the main body 31 of the fragrance box 3. A sliding unit is disposed between the two opposite walls of the main body 31 and the cover 32, whose sliding slot and sticking point cooperate with each other. The surface of two opposite walls of main body 31 which opposite the inner space 312 are respectively disposed with a sliding slot 313.

Multiple pores 321 are also set on the cover 32, the front and back wall of cover 32 are respectively disposed with a sticking point 322 by the left and right end.

The two sliding slots 313 of main body 31 are respectively clamped and connected to the sticking point 322 of the wall which is opposite the cover 3.

Before using, firstly take the fragrance box 3 out of the window 12 of main body 1. Parallelly pushing the cover 32 of the fragrance box 3, then the sticking point of the cover 32 is sliding in the two sliding slots 313 of main body 31 until the cover 32 is opened. Put the fragrance into the inner space 312 of the main body 31 of the fragrance box 3. Then parallelly pushes the cover 32 of fragrance box 3 in the opposite direction, make the cover 32 to cover the main body 31 of the fragrance box 3. Then put the fragrance box 3 which is already added with fragrance back to the window 12 of the main body 1.

The steam flows into the inner space of the main body 1 through the steam inlet 2; part of the steam flows into the inner space 312 of the main body 31 of the fragrance box 3 by the pores 311 of the main body 31 of the fragrance box 3, then overflows the fragrance, the steam sprays out of the steam outlets 11 from the pores 321 of the cover 32 of the fragrance box 3. Thereby the steam sprayed from said steam spraying nozzle is fragrant.

The fragrance box 3 can restrict the overflow of the steam to the fragrance, so the consumption quantity of the fragrance can be controlled and if necessary, partial pores 311 of the main body 31 of the fragrance box 3 or the partial pores 321 of the cover 32 are closed to further reduce the consumption quantity of the fragrance.

Although the present invention has been described with reference to the preferred embodiments thereof for carrying out the invention, it is apparent to those skilled in the art that a variety of modifications and changes may be made without departing from the scope of the present invention which is intended to be defined by the appended claims.

What is claimed is:

1. A steam spraying nozzle comprises a sealing main body provided with multiple steam outlets and a steam inlet which is connected to a steam generator; a window set on the main body, wherein said window is equipped with a fragrance box with multiple pores.

2. The steam spraying nozzle according to claim 1, wherein said fragrance box comprises an opening on the top side with a cover.

3. The steam spraying nozzle according to claim 1, wherein said fragrance box is rectangular; multiple pores are respectively set on the bottom wall\ left wall\ right wall and back wall of said fragrance box and said cover.

4. The steam spraying nozzle according to claim 1, wherein a sliding unit, is disposed between two opposite walls of said fragrance box and said cover; wherein said sliding unit comprises a sliding slot and sticking point cooperate with each other.
